(19) United States
(12) Patent Application Publication
(10) Pub. No.: US 2006/0057050 A1
(43) Pub. Date: Mar. 16, 2006

(54) Synthesis of boron carbide nanoparticles

(75) Inventors: Zhifeng Ren, Newton, MA (US); Jian Guo Wen, Urbana, IL (US); Jing Y. Lao, Clifton Park, NY (US); Wenzhi Li, Palmetto Bay, FL (US); Shuo Chen, Brighton, MA (US)

Correspondence Address: SONNENSCHEIN NATH & ROSENTHAL LLP;FOR PAULA EVANS, P.O. BOX 061080, CHICAGO, IL, 60606-1080, US

(73) Assignee: The Trustees of Boston College

(21) Appl. No.: 11/088,527

(22) Filed: Mar. 24, 2005

Related U.S. Application Data
(63) Continuation-in-part of application No. 10/339,849, filed on Jan. 10, 2003, now Pat. No. 6,911,260.
(60) Provisional application No. 60/347,808, filed on Jan. 11, 2002.

(51) Int. Cl. C01B 31/36

(52) U.S. Cl. 423/291

(57) ABSTRACT

The present invention relates generally to reinforced carbon nanotubes, and more particularly to reinforced carbon nanotubes having a plurality of microparticulate carbide or oxide materials formed substantially on the surface of such reinforced carbon nanotubes composite materials. In particular, the present invention provides reinforced carbon nanotubes (CNTs) having a plurality of boron carbide nanolumps formed substantially on a surface of the reinforced CNTs to reinforce the CNTs, enabling their use as effective reinforcing fillers for matrix materials to give high-strength composites. The present invention also provides methods for producing carbide reinforced CNTs.

### RELATED APPLICATIONS

This application is a continuation-in-part of U.S. patent application Ser. No. 10/339,849, filed on Jan. 10, 2003, which claims the benefit of U.S. Provisional Application Ser. No.60/347,808, filed on Jan. 11, 2002, all of which are hereby incorporated herein by reference in their entirety.

### GOVERNMENT SUPPORT

The present invention was made with partial support from The US Army Natick Soldier Systems Center (DAAD, Grant Number 16-00-C-9227), Department of Energy (Grant Number DE-FG02-00ER45805), The National Science Foundation (Grant Number DMR-9996289), The National Science Foundation (Grant Number NIRT-0304506), and The National Science Foundation (Grant Number CMS-0219836).

### FIELD OF THE INVENTION

The present invention relates generally to reinforced carbon nanotubes, and more particularly to reinforced carbon nanotubes having a plurality of microparticulate carbide materials formed substantially on the surface of such reinforced carbon nanotubes composite materials.

### BACKGROUND OF THE INVENTION

Reinforcing fillers are usually added to a matrix material to form high-strength composites. In order for the resulting composites to be useful, the reinforcing fillers must have a high load-bearing ability and binding affinity for the matrix. Carbon nanotubes (CNTs) have been added to matrix materials to form high-strength composites. However, the use of CNTs as reinforcing fillers, including multi-walled CNTs, has several disadvantages. Multi-walled CNTs have a tendency to pull out of, or slip from the matrix material, resulting in reduced load bearing ability. This is attributed to the fact that the interface between the matrix material and nanotube layers is very weak, thereby causing a “sword-in-sheath” type failure mechanism. Typically, only the outermost layer of multi-wall CNTs contributes to load bearing strength. (See, for example, D. Qian, et al. Appl. Phys. Lett., 76, 2868 (2000) and C. Bower, et al. Appl. Phys. Lett., 74, 3317 (1999)). Because of the weak van der Waals interaction between the CNTs cylindrical graphene sheets, improved bonding between carbon nanomaterials such as relatively “inert” CNTs and the matrix material is, therefore, essential for improved mechanical performance of the composite.

For high-strength CNT reinforced composites, the matrix material has to bind to the CNT reinforcing filler strongly (to prevent the two surfaces from slipping), so that an applied load (such as a tensile stress) can be transferred to the nanotubes. (See, for example, P. Calvert, Nature, 339, 210 (1999)). Several methods, including chemical functionalization of CNT tubule ends and side walls have been proposed and attempted to enhance bonding between CNTs and matrix material. (See, for example, J. Chen, et al. Science, 282, 95 (1998); A. Grag, et al. Chem. Phys. Lett., 295, 273 (1998), and S. Delpeux, et al. AIP Conf. Proc., 486, 470 (1999)). However, no significant improvement in mechanical properties has been observed after such modification. Chemical coating of both multi-wall and single-wall CNTs with metals and metallic oxides have also been reported for applications such as heterogeneous catalysis and one-dimensional nanoscale composites. (See, for example, T. W. Ebbesen, et al. Adv. Mater., 8, 155 (1996), X. Chen, et al. Compos. Sci. Technol., 60, 301 (2000), and L. M. Ang et al. Carbon, 38, 363 (2000)). The bonding between the coating materials and CNTs is, however, not strong enough to result in efficient load transfer. Thus, there exists a need in the art to improve the interaction between CNT reinforcing fillers and matrix materials in order to confer high mechanical strength to CNT reinforced composites and enable their commercial use in the manufacture of high-strength, light-weight mechanical and electrical device components.

### SUMMARY OF THE INVENTION

The present invention provides CNTs comprising a plurality of microparticulate carbide or nitride material that provide a reinforcing effect on the CNT matrix, thereby conferring improved mechanical properties in the composite materials comprising them as reinforcing fillers. In particular, the present invention provides microparticulate carbide reinforced CNTs comprising boron carbide nanolumps formed on the surface of CNTs. The present invention also provides a method of producing microparticulate carbide reinforced CNTs. Specifically, the present invention provides the use of microparticulate carbide reinforced CNTs having boron carbide nanolumps formed on the surface of the CNTs to enable their use as reinforcing composite fillers in producing high strength composite materials.

The load transfer efficiency between a matrix material and multi-walled CNTs is increased when the inner layers of multi-walled CNTs are bonded to a matrix material. The present invention provides reinforced CNTs having boron carbide (BₓC_{y}) nanolumps formed substantially on the surface of the CNTs. The BₓC_{y} nanolumps reinforce CNTs by bonding not only to the outermost layer, but also to the inner layers of the CNTs, and promote the bonding of matrix material to the inner layers of multi-walled CNTs. The load transfer efficiency also increases dramatically when the shape of the CNTs allow for a greater surface area along the CNTs and the matrix material. Boron carbides of the formula BₓC_{y} are covalent bonding compounds with superior hardness, excellent mechanical, thermal and electrical properties. They are therefore excellent reinforcing material for CNTs. The carbide modified CNTs of the invention have superior mechanical properties as fillers for matrix materials, enabling the production of high-strength composites.

The present invention provides the synthesis of BₓC_{y} nanolumps on the surface of multi-wall CNTs. In one embodiment, present invention uses a solid-state reaction between a boron source material and pre-formed CNTs to form boron carbide (BₓC_{y}) nanolumps on the surface of CNTs. In one embodiment, the BₓC_{y} nanolumps are formed by a solid-state reaction of magnesium diboride (MgB₂) and pre-formed CNTs. The BₓC_{y} nanolumps are preferably bonded to the inner layers of multi-wall CNTs. In one embodiment, the bonding between the BₓC_{y} nanolumps and the CNTs is covalent chemical bonding. Typically, such covalent chemical nanolumps bonding between BₓC_{y} and CNTs occurs in the absence of a secondary phase separation at the interface.

The present invention also provides methods of using reinforced CNTs having BₓC_{y} nanolumps as reinforcing fillers in composites. The carbide reinforced CNTs of the invention can be used as additives to provide improved strength and reinforcement to plastics, ceramics, rubber, concrete, epoxies, and other materials, by utilizing standard fiber reinforcement methods for improving material strength. Additionally, the carbide reinforced CNTs comprising BₓC_{y} nanolumps are potentially useful for electronic applications, such as use in electrodes, batteries, energy storage cells, sensors, capacitors, light-emitting diodes, and electrochromic displays, and are also suited for other applications including hydrogen storage devices, electrochemical capacitors, lithium ion batteries, high efficiency fuel cells, semiconductors, nanoelectronic components and high strength composite materials. Furthermore, the methods of the present invention provide large scale, cost efficient synthetic processes for producing linear and branched carbide reinforced CNTs having BₓC_{y} nanolumps.

The carbide-reinforced CNTs of the present invention have several advantages over current reinforcing materials known in the art. CNTs are good reinforcing fillers for composites because of their very high aspect ratio, large Young's Modulus, and low density. Carbide reinforced CNTs of the invention containing BₓC_{y} nanolumps are superior reinforcing fillers for incorporation within a matrix material because the modification of carbon nanotube morphology by the BₓC_{y} nanolumps increases the load transfer efficiency between CNTs and the matrix material. The shape modification of CNTs by BₓC_{y} nanolumps provides a greater CNT surface area that results in stronger adhesion of the matrix material, while nanolump bonding to the inner layers of multi-wall CNTs allows for a greater load transfer from matrix materials to CNTs. Although the carbide reinforced CNT materials of the invention are illustrated with boron carbide (BₓC_{y}) as the reinforcing material, it will be understood by one skilled in the art that other metallic and non-metallic carbides, metallic and non-metallic nitrides may be substituted for boron carbide without departing from the scope of the invention. Metallic carbides, such as boron carbides, are among the hardest solids known in the art, along with diamond and boron nitride. BₓC_{y} has a high melting point, high modulus, low density, large neutron capture section, superior thermal and electrical properties, and is chemically inert.

In addition, the present invention provides a method of producing reinforced carbon nanotubes (CNTs) having a plurality of B₄C nanoparticles through a thermal decomposition of an amount of MgB₂. The method comprises growing a plurality of CNTs and mixing an amount of MgB₂ with the CNTs to produce a mixture. Next, the method comprises placing the mixture in a reaction vessel and placing the reaction vessel into a heating device. Further, the method comprises creating a desired pressure within the heating device, heating the mixture by raising a starting temperature of the heating device to a first desired temperature and maintaining the first desired temperature for a first desired period of time. Such heating allows for an amount of MgB₂ to undergo thermal decomposition. Next, the heating device heats the mixture to a second desired temperature for a second desired period of time to allow for a reaction of an amount of boron with an amount of carbon to form B₄C nanoparticles and thereby produce a reinforce-CNT.

Further, the current invention provides a method of producing a composite material reinforced with reinforced-CNTs having a plurality of B₄C nanoparticles. The method comprises mixing an amount of MgB₂ with an amount of carbon nanotubes (CNTs) to produce a mixture, placing the mixture in a reaction vessel and placing the reaction vessel into a heating device. Further, the method comprises creating a desired pressure within the heating device and heating the mixture by raising a starting temperature of the heating device to a first desired temperature and maintaining the first desired temperature for a first desired period of time. Such heating allows for an amount of MgB₂ to undergo thermal decomposition. Next, the method includes heating the mixture to a second desired temperature for a second desired period of time to allow for a reaction of an amount of boron with an amount of carbon to form reinforced-CNTs having a plurality of B₄C nanoparticles, providing a composite material, and adding the reinforced-CNTs to the composite material.

Additionally, the present invention comprises a method of producing CNTs reinforced with B₄C nanoparticles comprising mixing an amount of MgB₂ with an amount of carbon nanotubes (CNTs) to produce a mixture wherein the amount of MgB₂ and the amount of CNTs are selected in order to produce a desired ratio of B to C in a reinforced CNT. Next, the method comprises placing the mixture in a plasma pressure compact device, creating a desired pressure within the plasma pressure compact device and passing a desired current through the mixture in order to generate a desired amount of heat for a desired period of time. Finally, the method comprises removing the reinforced-CNT product from the plasma pressure compact device.

The foregoing and other aspects, features and advantages of the present invention will become apparent from the figures, description of the drawings and detailed description of particular embodiments.

### BRIEF DESCRIPTION OF THE DRAWINGS

The present invention will be further explained with reference to the attached drawings. The drawings shown are not necessarily to scale, with emphasis instead generally being placed upon illustrating the principles of the present invention.

FIG. 1 shows scanning electron microscope (SEM) images of multi-wall CNTs. FIG. 1(a) shows multi-wall CNTs before the formation of BₓC_{y} nanolumps. FIG. 1(b) shows multi-wall CNTs after the formation of BₓC_{y} nanolumps.

FIG. 2 shows transmission electron microscope (TEM) images of a multi-wall CNT with BₓC_{y} nanolumps. FIG. 2a shows a multi-wall CNT at low magnification. FIG. 2b shows a multi-wall CNT at medium magnification.

FIG. 3 shows images of BₓC_{y} nanolumps on a multi-wall CNT. FIG. 3(a) shows a high-resolution transmission electron microscope (HRTEM) image of a BₓC_{y} nanolump on a multi-wall carbon nanotube. FIG. 3(b) shows an enlarged image of the upper portion of FIG. 3a. FIG. 3c shows a fast-Fourier transformation (FFT) image of FIG. 3b. FIG. 3d shows the twin boundaries along (101) or (01\overline{1}) planes of BₓC_{y}

FIG. 4 shows high-resolution transmission electron microscope (HRTEM) images. FIG. 4a shows the reacted area of a multi-wall carbon nanotube. FIG. 4b shows the interface between BₓC_{y} nanolumps and a carbon nanotube is sharp and well bonded. FIG. 4c shows an epitaxial relationship between BₓC_{y} nanolump and a multi-wall carbon nanotube with a (101) plane perpendicular to the zigzag-type nanotube axis.

FIG. 5 is a schematic drawing illustrating carbon nanotube (CNT) morphologies.

FIG. 6 shows low magnification TEM photomicrographs of CNTs grown at varying gas pressures. FIG. 6a shows CNTs grown at a gas pressure of 0.6 torr. FIG. 6b shows CNTs grown at a gas pressure of 50 torr. FIG. 6c shows CNTs grown at a gas pressure of 200 torr. FIG. 6d shows CNTs grown at a gas pressure of 400 torr. FIG. 6e shows CNTs grown at a gas pressure of 600 torr. FIG. 6f shows CNTs grown at a gas pressure of 760 torr.

FIG. 7 shows high magnification TEM photomicrographs of CNTs grown at various gas pressures. FIG. 7a shows CNTs grown at a gas pressure of 0.6 torr. FIG. 7b shows CNTs grown at a gas pressure of 200 torr. FIG. 7c shows CNTs grown at a gas pressure of 400 torr. FIG. 7d shows CNTs grown at a gas pressure of 760 torr.

FIG. 8 shows SEM photomicrographs of symmetrically branched (Y-shaped) CNTs. FIG. 8a shows symmetrically branched (Y-shaped) CNTs at low magnification (scale bar=1 μm). FIG. 8b shows symmetrically branched (Y-shaped) CNTs at high magnification (scale bar=200 nm).

FIG. 9 shows TEM photomicrographs branched CNT Y-junctions. FIG. 9a shows branched CNT Y-junctions with straight hollow arms and uniform diameter (scale bar=100 nm). FIG. 9b shows branched CNT Y-junctions with a pear-shaped particle cap at tubule terminal (scale bar=100 nm) (expanded in bottom inset) and XDS photomicrograph (top right inset) showing composition of particle. FIG. 9c shows branched CNT Y-junctions shows a branched CNT with a double Y-junction (scale bar=100 nm) (open tubule shown in inset). FIG. 9d shows branched CNT Y-junctions shows a high resolution partial image of a well graphitized, hollow tubule Y-junction.

FIG. 10 shows SEM photomicrographs of CNTs grown at various gas pressures. FIG. 10a shows CNTs grown at a gas pressure of 0.6 torr. FIG. 10b shows CNTs grown at a gas pressure of 50 torr. FIG. 10c shows CNTs grown at a gas pressure of 200 torr. FIG. 10d shows CNTs grown at a gas pressure of 400 torr. FIG. 10e shows CNTs grown at a gas pressure of 600 torr. FIG. 10f shows CNTs grown at a gas pressure of 760 torr.

FIG. 11 show low magnification TEM photomicrographs of “bamboo-like” CNTs synthesized at various temperatures. FIG. 11a shows CNTs synthesized at 800° C. FIG. 11b shows CNTs synthesized at 950° C. FIG. 11c shows CNTs synthesized at 1050° C. FIG. 11d shows CNT yield dependence on reaction temperature.

FIG. 12 shows high-resolution TEM photomicrographs of “bamboo-like” CNTs synthesized at various temperatures. FIG. 12a shows “bamboo-like” CNTs synthesized at 650° C. FIG. 12b shows “bamboo-like” CNTs synthesized at 800° C. FIG. 12c shows “bamboo-like” CNTs synthesized at 1050° C.

FIG. 13 is a scanning electron micrograph (SEM) image of reinforced CNT materials with surface bound magnesium oxide (MgO) showing epitaxial growth of MgO nanostructures on CNT tubules.

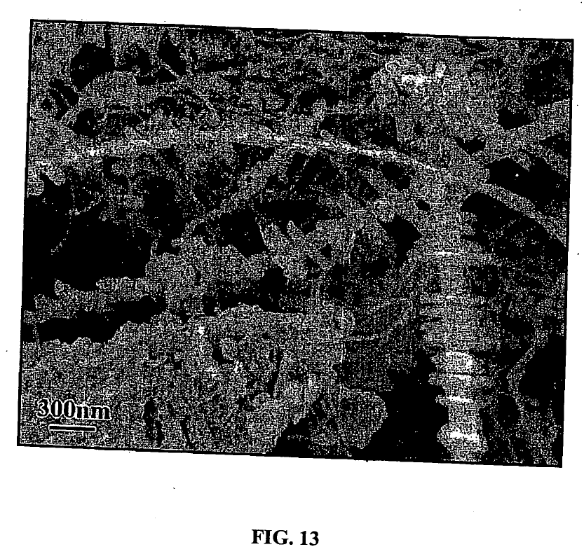

FIG. 14 shows reinforced CNT materials with surface bound amorphous boron oxide (B₂O₃) nanolumps on multi-walled CNT tubules. FIG. 14a shows a scale bar equal to 100 nanometers. FIG. 14b shows a scale bar equal to 200 nanometers. FIG. 14c shows a scale bar equal to 10 nanometers.

FIG. 15a shows SEM images of multiwall CNTs. FIG. 15b shows HRTEM images of multiwall CNTs.

FIG. 16a shows TEM images of CNTs and B₄C nanoparticles wherein B₄C has formed at an end of a CNT. FIG. 16b shows TEM images of CNTs and B₄C nanoparticles wherein B₄C has formed at broken places of the CNTs of the present invention.

FIG. 17a shows a medium magnification image of B₄C nanoparticles. FIG. 17b shows a high magnification image of B₄C nanoparticles.

FIG. 18a shows a medium magnification TEN image of B₄C nanoparticles. FIG. 18b shows a high TEN image of B₄C nanoparticles. FIG. 18c shows a FFT image of the image of FIG. 18b.

FIG. 19 shows an XRD spectra of the as-made (bottom) and after purification (top) B₄C nanoparticles.

FIG. 20a shows a low magnification SEM image of a B₄C and CNT mixture of the present invention. FIG. 20b shows a high magnification SEM image of a B₄C and CNT mixture of the present invention.

FIG. 21 shows an XRD spectra of a B₄C and CNT nanocomposite of the present invention.

FIG. 22a shows a low magnification TEM image of a B₄C and CNT mixture of the present invention. FIG. 22b shows a high magnification TEM image of a B₄C and CNT mixture of the present invention.

While the above-identified drawings set forth preferred embodiments of the present invention, other embodiments of the present invention are also contemplated, as noted in the discussion. This disclosure presents illustrative embodiments of the present invention by way of representation and not limitation. Numerous other modifications and embodiments can be devised by those skilled in the art which fall within the scope and spirit of the principles of the present invention.

### DETAILED DESCRIPTION OF THE INVENTION

The present invention provides CNTs comprising a plurality of microparticulate carbide materials that exist substantially on the CNT surface and function as effective reinforcing agents. Specifically, the present invention provides reinforced CNTs having a plurality of microparticulate carbide nanolumps formed on the surface of the CNTs. The present invention also provides a method of producing reinforced CNTs having BₓC_{y} nanolumps formed on the surface of the CNTs. The present invention also provides a method of using reinforced CNTs having BₓC_{y} nanolumps formed on the surface of the CNTs as reinforcing composite fillers.

The terms “boron carbide nanolump” and “BₓC_{y} nanolump” refer to a nanoscale aggregate comprising a boron carbide microparticles on a surface of a nanoscale carbon material, including but not, limited to carbon nanotubes. Nanolumps are typically irregular in shape.

The term “reinforced carbon nanotube” refer to strengthened CNTs in which more force or effectiveness is given to the carbon nanotube. In one embodiment of the present invention, CNTs are reinforced by reducing the amount that the inner layers of a multi-walled CNT slip from the outer layers of the CNT. In a currently preferred embodiment, CNTs are reinforced by bonding a microparticulate carbide material substantially to the surface of the CNT which binds to the inner walls of the CNTs.

The term “matrix material” refers to any material capable of forming a composite with reinforced CNTs. Examples of matrix materials include, but are not limited to, plastics, ceramics, metals, metal alloys, rubber, concrete, epoxies, glasses, polymers, graphite, and mixtures thereof. A variety of polymers, including thermoplastics and resins, can be used to form composites with the reinforced CNTs of the present invention. Such polymers include, but are not limited to, polyamides, polyesters, polyethers, polyphenylenes, polysulfones, polycarbonates, polyacrylites, polyurethanes or epoxy resins.

The term “carbide forming source” refers to any suitable material capable of forming a carbide material. The carbide forming source can be metallic or non-metallic. Preferred carbide forming source include, but are not limited to, magnesium diboride (MgB₂), aluminum diboride (AlB₂) calcium diboride (CaB₂), and gallium diboride (GaB₂). Preferably the carbide forming source exists in the form of a carbide forming source powder.

A “carbide material” as referred to herein is afforded the meaning typically provided for in the art. More specifically, a carbide material is a binary solid compound of carbon and another element. Elements capable of forming carbide materials can be metallic or non-metallic. Examples of elements that can form carbides include, but are not limited to, boron (B), calcium (Ca), tungsten (W), silicon (Si), nobium (No), titanium (Ti), and iron (Fe). Carbides can have various ratios between carbon and the element capable of forming the carbide material. A presently preferred carbide material of the present invention is boron carbide (BₓC_{y}).

The carbide materials on the surface of CNTs can be either in the form of a contiguous coating layer or a non-contiguous surface layer, such as, for example, in the form of nanolumps. In one embodiment, the carbide material is BₓC_{y} in a non-contiguous surface layer in the form of nanolumps. In one embodiment, the interface between BₓC_{y} nanolumps and CNTs is sharp, in which there is no amorphous layer in between the BₓC_{y} nanolumps and CNTs. The BₓC_{y} nanolumps may be chemically bound to the CNT surface by covalent bonding or by van der Waals type attractive forces. In one embodiment, the BₓC_{y} nanolumps are bound to CNTs covalently.

The BₓC_{y} nanolumps of the present invention typically have an average particle size from about 10 nanometers (nm) to about 200 nm. Preferably, the BₓC_{y} nanolumps have an average diameter of about two to three times the average diameter of CNTs. In one embodiment, the BₓC_{y} nanolumps have an average diameter ranging from about 50 run to about 100 nm. In one embodiment, the BₓC_{y} nanolumps have an average diameter of about 80 nm. Those skilled in the art will recognize that particles of various diameters are within the spirit and scope of the present invention.

The BₓC_{y} lump density on the reinforced CNTs of the invention can vary over a wide range. In one embodiment, the nanolumps are isolated nanolumps. The spacing variation between adjacent nanolumps on a CNT can range from about 30 nm to about 500 nm and is dependent on the particle density on the CNT surface, which is expressed as a ratio of the percentage of boron atoms to carbon atoms in the boron carbide BₓC_{y} (atom % carbon). In one embodiment, the spacing between BₓC_{y} nanolumps is from about 50 nm to about 100 nm. Those skilled in the art will recognize that many spacing variations are within the spirit and scope of the present invention.

In one embodiment of the present invention, the BₓC_{y} nanolumps in the reinforced CNTs is crystalline. In one embodiment of the present invention, the BₓC_{y} nanolumps in the reinforced CNTs is amorphous. The crystal geometries of the BₓC_{y} nanolumps include, but are not limited to, rhombohedral, tetragonal and orthorhombic. Those skilled in the art will recognize that various geometries are within the spirit and scope of the present invention.

The ratio of boron to carbon in the BₓC_{y} nanolumps is variable. Boron carbides typically exist as a stable single phase, with a homogeneity ranging from about 8 atom % carbon to about 20 atom % carbon. Examples of boron carbon ratios within this range are B₄C and B₁₀C. The boron carbide nanolumps in the reinforced CNTs of the invention have the general formulas BₓC_{y} wherein x ranges from about 4 to about 50 and y ranges from about 1 to about 4. In one embodiment, the stable BₓC_{y} structures are rhombohedral with a stoichiometry of B₁₃C, B₁₂C₃ or B₄C. In one embodiment, the stable BₓC_{y} structures are tetragonal with a stoichiometry of B₅₀C₂, B₅₀C, B48C₃, B₅₁C, B₄₉C₃. In one embodiment, the stable BₓC_{y} structures are orthorhombic with a stoichiometry of B₈C. In one embodiment, stable BₓC_{y} structures may include B₁₂C, B₁₂C₂ and B₁₁C₄. In one embodiment, the ratio of boron to carbon is 4 boron atoms to one carbon atom (B₄C).

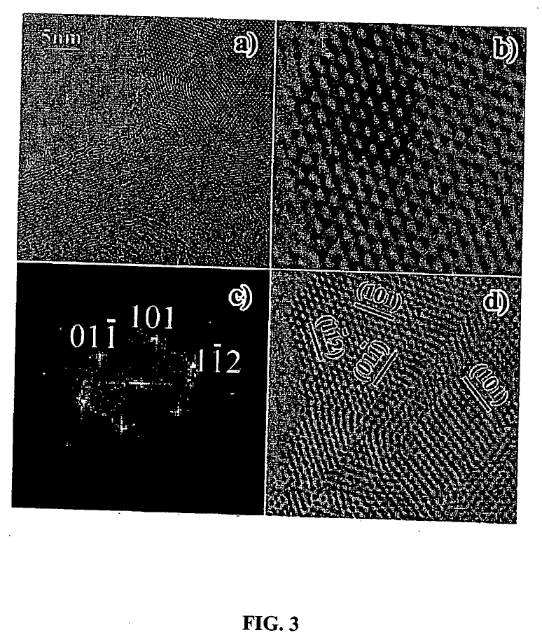

Typically, twin boundaries can be observed in B₄C nanolumps. In one embodiment, the twin boundary is along either (101) or (01\overline{1}) planes, as shown in FIG. 3d.

FIG. 3 shows images of BₓC_{y} nanolumps on a multi-wall CNTs. FIG. 3a shows an HRTEM image of a BₓC_{y} nanolump on a multi-wall carbon nanotube. FIG. 3b shows an enlarged image of the upper portion of FIG. 3a. FIG. 3c shows a FFT image of FIG. 3b. The simulated image, as shown in the inset of FIG. 3b, and the indexing of the FFT image, as shown in FIG. 3c, were carried out by using structural parameters of BₓC_{y} and zone axis of (\overline{1}11). FIG. 3d shows the twin boundaries along (101) or (01\overline{1}) planes of BₓC_{y}. The main parameters for the simulated image, as shown in the inset of FIG. 3b, are: spherical aberration coefficient=0.5 mm, thickness=10 nm, and defocus=50 nm.

In one embodiment, BₓC_{y} nanolumps of the invention provide materials such as carbon fibers and CNTs with a knotted-rope-shaped or bone-shaped morphology. Knotted-rope-shaped CNTs and bone-shaped CNTs can be excellent reinforcing fillers to increase strength and toughness due to a more effective load transfer between CNTs and matrix materials. The lumps or knots allow for mechanical matrix-CNT interlocking. Those skilled in the art will recognize that various shapes are within the spirit and scope of the present invention.

Another aspect of the present invention is a method of producing CNTs having boron carbide (BₓC_{y}) nanolumps formed on the surface of the CNTs. The method of the present invention can be applied to CNTs comprising any morphology including aligned or non-aligned linear arrays. Preferably, the CNTs have a branched, multi-walled morphology. Those skilled in the art will recognize that various morphologies are within the spirit and scope of the present invention.

In one embodiment, the carbide forming source is a metallic material. In one embodiment, the carbide forming material is a non-metallic material. The carbide forming source may be any material capable of forming a carbide on the CNT surface. In one embodiment, the carbide forming sources include, but are not limited to, magnesium diboride (Mg B₂), aluminum diboride (AlB₂), calcium diboride (CaB₂) and gallium diboride (GaB₂).

BₓC_{y} nanolumps can be grown on CNTs using any suitable method. In one embodiment, BₓC_{y} nanolumps are grown on CNTs by using a reaction between a boron source and CNTs. Any suitable boron source known in the art can be used. Suitable boron sources include, but are not limited to, magnesium diboride (MgB₂) and aluminum diboride (AlB₂). In one embodiment, the boron source is MgB₂. In one embodiment, the boron source is in the form of a powder. In one embodiment, the powder comprises particles with an average grain size of about 0.1 micrometer (μm) to about 100 micrometers (μm). In one embodiment, the powder comprises particles with an average grain size of about 1 micrometer. The synthesis of magnesium diboride (MgB₂) powders is accomplished by combining elemental magnesium and isotopicaly pure boron by known methods.

In one embodiment, the boron source used in the present invention decomposes at a temperature of between about 100° C. to about 1000° C., preferably, at a temperature of about 600° C. Thermally decomposed boron is typically more reactive chemically; a solid-state reaction can, therefore, be performed at relatively low temperatures. In one embodiment, a reaction is performed at temperatures ranging from about 500° C. to about 2000° C. In one embodiment, a reaction is performed at temperature of ranging from about 1000° C. to about 1250° C.

In one embodiment, the CNTs used for producing reinforced CNTs of the present invention may be purified by any suitable method known in the art prior to introduction of BₓC_{y} nanolumps. In one embodiment, CNTs are purified by washing with a mineral acid. Examples of suitable mineral acids include, but are not limited to, hydrofluoric acid (HF), hydrochloric acid (HCl), hydrobromic acid (HBr), hydroiodic acid (HI), sulfuric acid (H₂SO₄) or nitric acid (HNO₃). Those skilled in the art will recognize that various methods of purification are within the spirit and scope of the present invention. Further, those skilled in the art will recognize that various mineral acids are within the spirit and scope of the present invention.

In one embodiment of the present invention, the purified CNTs nanotubes are then mixed with the boron source powder. In one embodiment, the CNTs and the boron source undergo gentle mechanical mixing following which the mixture is wrapped with a metal foil to form an assembly. Metal foils to be used in the present invention include, but are not limited to, transition metal foils. In one embodiment, the metal foil is Tantalum (Ta). In one embodiment, the assembly is then placed in a ceramic tube furnace, wherein a vacuum of about 0.5 torr is created by a mechanical pump. In one embodiment, the reaction area is localized only at the area where boron is present. That is, no surface diffusion of boron is observed in the solid-state reaction. In one embodiment, the reaction area is not localized only at the area where boron is present.

In one embodiment, BₓC_{y} nanolumps are formed via chemical vapor deposition (CVD). In one embodiment of the present invention, CVD of boron carbide such as plasma enhanced chemical vapor deposition (PECVD), hot filament chemical vapor deposition (HFCVD), and synchrotron radiation chemical vapor deposition (SRCVD) using reactive gas mixtures such as BCl₃—CH₄—H₂, B₂H₆—CH₄—H₂, B₅H₉—CH₄, BBr₃—CH₄—H₂, C₂B₁₀H₁₂, BCl₃—C₇H₈—H₂, B(CH₃)₃ and B(C₂H₅)₃ are used. One embodiment of the present invention uses a solid state reaction between a carbide forming source and CNTs. Another embodiment, of the present invention uses a solid state reaction between a boron source and CNTs. Those skilled in the art will recognize that various methods of forming BₓC_{y} nanolumps are within the spirit and scope of the present invention.

In addition, the present invention provides a method of manufacturing reinforced carbon nanotubes having a plurality of boron carbide nanolumps formed substantially on a surface of pre-formed CNTs comprising the steps of: (1) purifying a plurality of carbon nanotubes by washing with a mineral acid; (2) mixing the plurality of carbon nanotubes with a boron source powder to form a mixture of carbon nanotubes and boron source powder; (3) wrapping the mixture of carbon nanotubes and boron source powder within a metal foil; (4) placing the metal foil containing the mixture of carbon nanotubes and boron source powder in a ceramic tube furnace; (5) pumping the ceramic tube furnace to below about 0.5 torr by a mechanical pump; and (6) heating the ceramic tube furnace.

In one embodiment of the present invention, a material comprising a plurality of reinforced carbon nanotubes having a plurality of boron carbide nanolumps formed substantially on the surface of the CNTs is used as reinforcing fillers for materials comprising the step of combining the plurality of reinforced carbon nanotubes and a matrix material to form a high-strength composite.

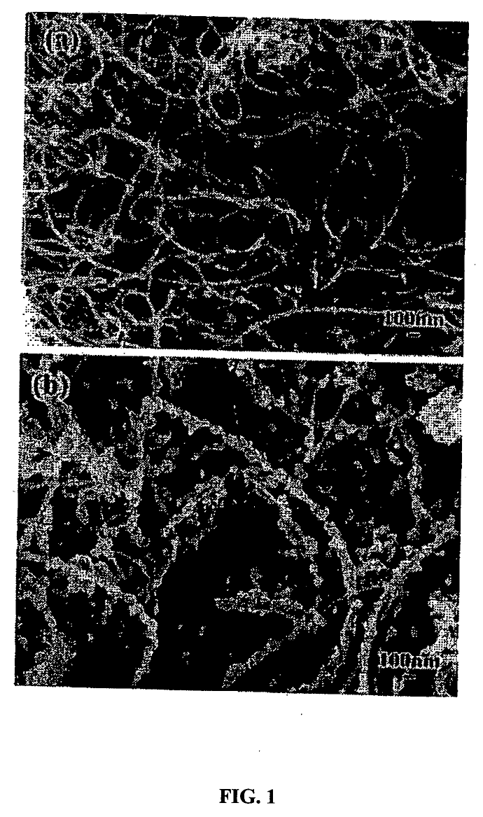

FIG. 1a shows a SEM image of the CNTs before the growth of boron carbide nanolumps. FIG. 1b shows a SEM image of BₓC_{y} nanolumps on the surface of multi-wall carbon nanotubes. The BₓC_{y} nanolumps form into a desired morphology, individual nanoparticles instead of a homogeneous layer on the surface of multi-wall carbon nanotubes. The average particle size of the BₓC_{y} nanolumps is about 80 nm in diameter, which is two or three times of the average diameter of CNTs. The lump density on a carbon nanotube varies dramatically, with a spacing variation between adjacent nanolumps from about 30 nm to about 500 nm.

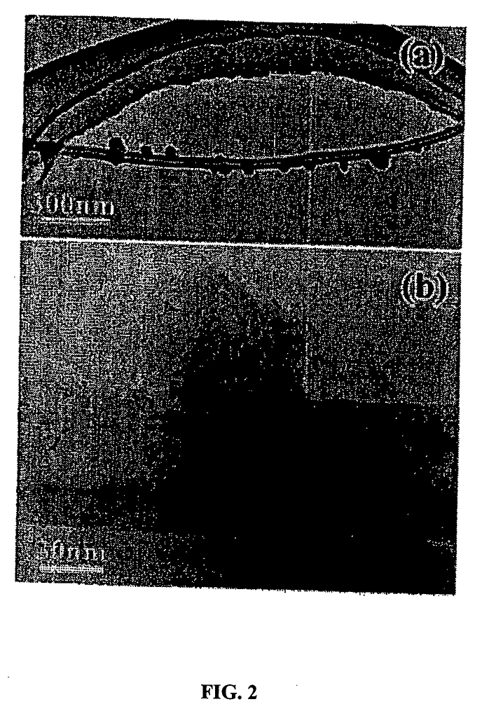

FIG. 2a and FIG. 2b show TEM images of BₓC_{y} nanolumps on multi-wall CNTs at low and medium magnifications, respectively. The average particle size shown in FIG. 2a is about 50 nm, smaller than that shown in FIG. 2b. As shown in FIG. 2a and FIG. 2b, the reaction between boron and CNTs is confined and the main structure of multi-wall CNTs remains unchanged. X-ray energy dispersive spectrometer (EDS) analysis on the composition of the nanolumps shows that the nanolumps contain only carbon. No magnesium (Mg) or Boron (B) were detected. The Mg from the decomposition of magnesium diboride (MgB₂) becomes vapor at the reaction temperature of about 1100° C. to about 1150° C. and was pumped out. But the existence of boron can not be excluded because boron can not be detected by the EDS system, since the low energy x-rays from boron atoms were absorbed by the detector.

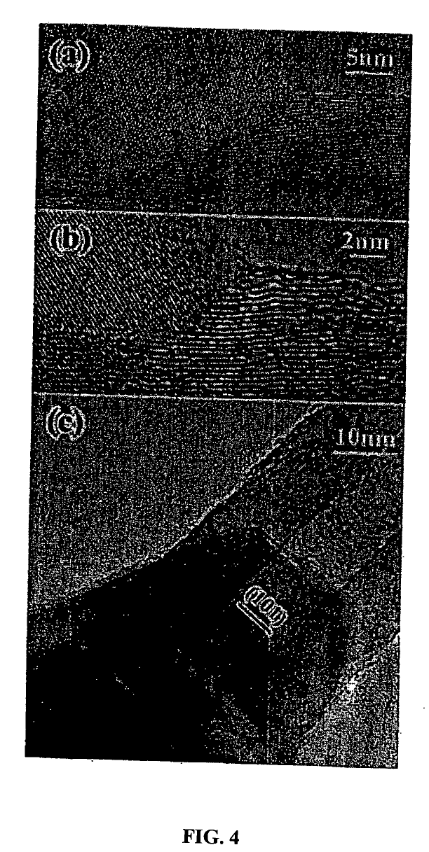

FIG. 4a shows an interface between BₓC_{y} nanolump and multi-wall carbon nanotube. Part of the multi-wall CNTs is reacted with boron by a solid state reaction, therefore no lattice fringes of CNTs can be observed at the bottom portion of the BₓC_{y} nanolump. The solid state reaction area is localized only at the area where there is boron. No surface diffusion of boron is observed in the solid-state reaction. As shown by the HRTEM images of FIG. 4a and FIG. 4b, the interface between BₓC_{y} nanolumps and CNTs is sharp. No amorphous layer was found at the interface between BₓC_{y} nanolumps and CNTs. An epitaxial relationship between CNTs and BₓC_{y} nanolumps is shown in FIG. 4c and supports the conclusion of strong interface between BₓC_{y} nanolumps and CNTs. Inner layers of CNTs at the reaction area are also bonded to BₓC_{y} as shown in FIG. 4a and FIG. 4b. The bonding between BₓC_{y} nanolumps and CNTs is strong, most likely, a covalent bonding, because the bonding between boron atoms and carbon atoms inside BₓC_{y} is covalent.

The strong bonding at the interface between BₓC_{y} nanolumps and CNTs can prevent the breaking at the interface between BₓC_{y} nanolumps and CNTs during load transfer. Bone-shaped short fibers were reported to be ideal reinforcing fillers to increase strength and toughness due to a more effective load transfer. Therefore, the modification of CNT morphology by BₓC_{y} nanolumps increases the load transfer between the nanotubes and the matrix of the present invention. Moreover, inner layers of multi-wall CNTs are also bonded to BₓC_{y} nanolumps, so the inner layers can also contribute to load carrying, instead of only the outmost layer.

Reinforced CNTs can be used to form or reinforce composites with other materials, especially a dissimilar material. Suitable dissimilar materials include, but are not limited to, metals, ceramics, glasses, polymers, graphite, and mixtures thereof. Such composites may be prepared, for example, by coating the reinforced CNTs with the dissimilar material either in a solid particulate form or in a liquid form. A variety of polymers, which include but are not limited to, thermoplastics and resins can be utilized to form composites with the products of the present invention. Such polymers include, but are not limited to, polyamides, polyesters, polyethers, polyphenylenes, polysulfones, polyurethanes or epoxy resins. In one embodiment, branched CNTs of the present invention can find application in construction of nanoelectronic devices and in fiber-reinforced composites. In one embodiment, the Y-junction CNT fibers of the invention are expected to provide superior reinforcement to composites compared to linear CNTs.

The carbon nanotubes comprised in the reinforced CNTs of the present invention can possess any of the several known morphologies. Examples of known CNT morphologies include, but are not limited to, linear, non-linear, branched, “bamboo-like”, and non-linear (“spaghetti-shaped”). Individual tubules of such CNTs can be either single or multi-walled. CNTs with the above morphologies are described, for example, in Li, et al., Appl. Phys. A: Mater. Sci. Process, 73, 259 (2001) and U.S. application Ser. No. 10/151,382, filed on May 20, 2002. Both references are hereby incorporated herein by reference in their entirety. In one embodiment of the present invention, the reinforced CNTs of the invention have a branched, multi-walled tubule morphology. Those skilled in the art will recognize that various morphologies are within the spirit and scope of the present invention.

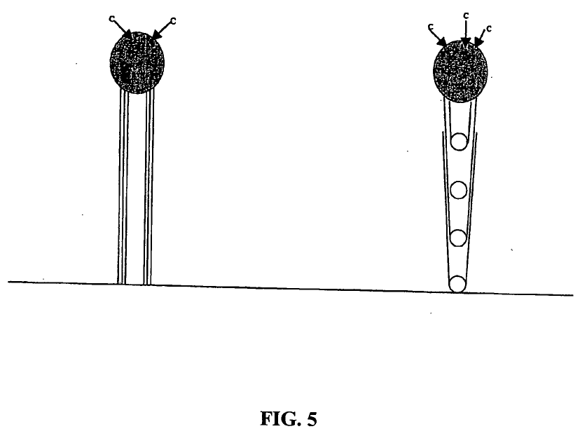

The CNTs in the carbide reinforced CNT materials of the present invention can be aligned or non-aligned. In one embodiment, the CNTs are non-aligned, substantially linear, concentric tubules with hollow cores, or capped conical tubules stacked in a bamboo-like arrangement. As shown in FIG. 5, the nanotube morphology can be controlled by choosing an appropriate catalyst material and reaction conditions. Depending on the choice of reaction conditions, relatively large quantities (kilogram scale) of morphologically controlled CNTs substantially free of impurity related defects, such as for example, from entrapment of amorphous carbon or catalyst particles, can be obtained. The linear CNTs obtained by the methods of the present invention have diameters ranging from about 0.7 nanometers (nm) to about 200 nanometers (nm) and are comprised of a single graphene layer or a plurality of concentric graphene layers (graphitized carbon). The nanotube diameter and graphene layer arrangement may be controlled by optimization of reaction temperature during the nanotube synthesis.

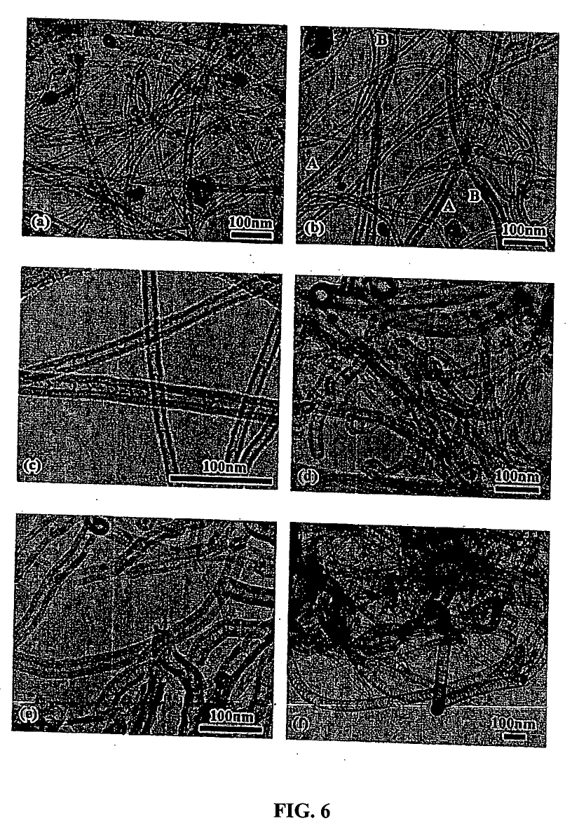

FIG. 6 shows low magnification TEM images of linear CNTs grown at low, intermediate and high gas pressures. The low magnification TEM images of linear CNTs of FIG. 6 are indicative that tubule morphology can be controllably changed by choice of gas pressure “feeding” into a reactor for CNT preparation. The control of gas pressures in the methods of the present invention is accomplished by regulating gas pressure of the gases feeding in to the reactor using conventional pressure regulator devices. FIG. 6a shows CNTs grown at a gas pressure of about 0.6 torr. CNTs grown at a gas pressure of about 0.6 torr predominantly have a morphology that consists of a tubular configuration, completely hollow cores, small diameter, and a smooth surface. FIG. 6b shows CNTs grown at a gas pressure of about 50 torr. CNTs grown at a gas pressure of about 50 torr have a morphology that is essentially similar to that at about 0.6 torr, except that a small amount of tubules have an end capped conically shaped stacked configuration (“bamboo-like”). FIG. 6c shows CNTs grown at a gas pressure of about 200 torr. The CNTs grown at a gas pressure of about 200 torr have a morphology of predominantly the end-capped, conical stacked configurations (“bamboo-like”) regardless of the outer diameters and wall thickness of the CNTs. As shown in FIG. 6c, the density of the compartments within individual tubules of the CNTs is high, with inter-compartmental distance inside the bamboo-like structures ranging from about 25 nm to about 80 nm.

At gas pressures greater than about 200 torr, an entirely bamboo-like morphology is obtained for the CNTs, with increased compartmental density. The inter-compartmental distances within the individual CNTs decrease with increasing gas pressure (about 10 nm to about 50 nm at about 400 torr and about 10 nm to about 40 nm at about 600 torr and about 760 torr, respectively). As shown in FIG. 6f, CNTs synthesized at about 760 torr have a wider tubule diameter of about 20 nm to about 55 nm. CNTs synthesized at about 760 torr have thin walls and smooth surfaces. In comparison to linear CNTs synthesized at a gas pressure of about 200 torr, CNTs synthesized at higher pressures of about 400 torr and about 600 torr are highly curved and have broken ends, as shown in FIG. 6d and FIG. 6e. The highly curved and broken ends are attributed to fracturing of the CNTs during the TEM specimen preparation, which is indicative that CNTs with a bamboo-like morphology may be readily cleaved into shorter sections compared to the tubular type.

In one embodiment of the present invention, CNTs have a relatively high degree of graphitization (process of forming a planar graphite structure or “graphene” layer). The complete formation of crystalline graphene layers, and the formation of multiple concentric layers within each tubule and hollow core, with minimal defects (such as defects typically caused by entrapment of non-graphitized, amorphous carbon and metal catalyst particles) is an important prerequisite for superior mechanical properties in CNTs.

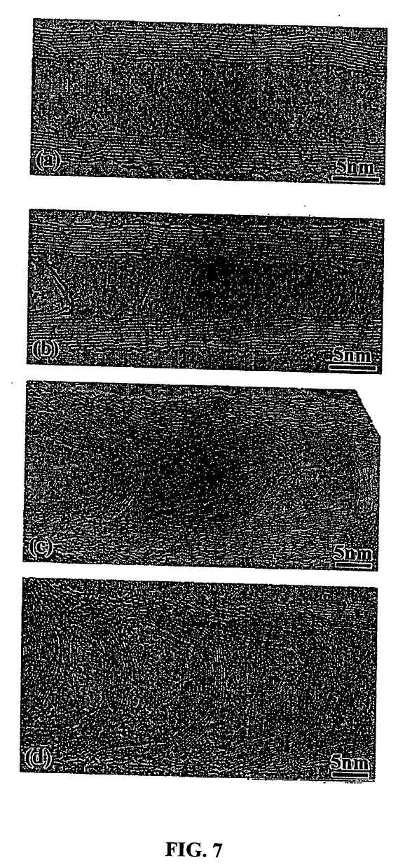

FIG. 7 shows TEM photomicrographs detailing morphologies of linear CNTs grown at different gas pressures. As shown in FIG. 7, CNTs grown at pressures between about 0.6 torr to about 200 torr have good graphitization, in which the walls of the CNTs comprise about 10 graphene layers which terminate at the end of the CNT that is distal from the substrate (i.e., the fringes are parallel to the axis of the CNT), and possess completely hollow cores. Linear CNTs grown at about 200 torr have tubule walls comprising about 15 graphene layers. Individual tubules are bamboo-like rather than completely hollow, with diaphragms that contain a low number (less than about 5) of graphene layers. Graphene layers terminate at the surface of the CNTs, with the angle between the fringes of the wall and the axis of the CNT (the inclination angle) being about 3°, as shown in FIG. 7b. FIG. 7c shows linear CNTs grown at intermediate gas pressures (about 400 torr to about 600 torr) have a bamboo-like structure. A bamboo-like structure typically has more of graphene layers in the walls and diaphragms of tubules (typically about 25 and about 10 graphene layers in the CNT walls and diaphragms, respectively), but less graphitization (lower crystallinity) due to a faster growth rate. Despite the low crystallinity, graphene layers terminate on the tubule surface with inclination angle of about 6°. As shown in FIG. 7d, CNTs grown at about 760 torr have higher graphitization than CNTs grown at about 400 torr to about 600 torr. In addition, CNTs grown at about 760 torr have a bamboo-like structural morphology consisting of parabolic-shaped layers stacked regularly along the symmetric axes of the CNTs. The graphene layers terminate within a short length along growth direction on the surface of the CNTs resulting in a high density of exposed edges for individual layers. As shown in FIG. 7(d), the inclination angle of the fringes on the wall of the CNTs is about 13°. The high number of terminal carbon atoms on the tubule surface is expected to impart differentiated chemical and mechanical properties in the CNTs as compared with hollow, tubular type, and render the CNTs more amenable for attachment of organic molecules.

In one embodiment, CNTs can comprise a branched (“Y-shaped”) morphology, referred to herein as “branched CNTs”, wherein the individual arms constituting branched tubules are either symmetrical or unsymmetrical with respect to both arm lengths and the angle between adjacent arms. In one embodiment, the Y-shaped CNTs exist as (1) a plurality of free standing, branched CNTs attached to the substrate and extending outwardly from the substrate outer surface; and (2) one or more CNTs with a branched morphology wherein the CNT tubule structures have Y-junctions with substantially straight tubular arms and substantially fixed angles between said arms.

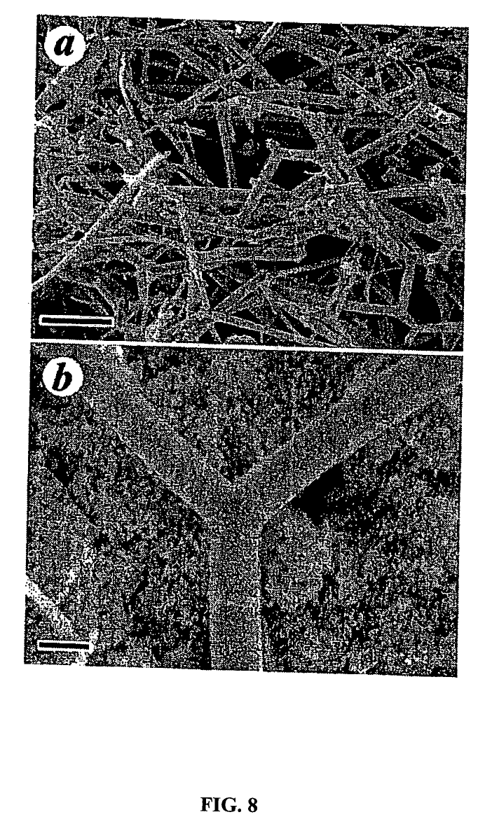

As seen in FIG. 8, branched CNTs can comprise a plurality of Y-junctions with substantially straight arms extending linearly from said junctions. In one embodiment, the majority of branched CNTs possess Y-junctions having two long arms that are a few microns long (about 2 μm to about 10 μm), and a third arm that is shorter (about 0.01 μm to about 2 μm). In one embodiment, CNTs with Y-junctions comprising three long arms (up to about 10 μm), and with multiple branches forming multiple Y-junctions with substantially linear, straight arms can be also obtained by the method of the invention. As shown in FIG. 8b, a high magnification SEM micrograph shows that the branched CNTs of the invention possess Y-junctions that have a smooth surface and uniform tubule diameter about 2000 nm. In one embodiment, the angles between adjacent arms are close to about 120°, thereby resulting in branched CNTs that have a substantially symmetric structure. Y-junctions have a substantially similar structural configuration, regardless of the varying tubule diameters of the CNTs. Those skilled in the art will recognize that various configuration and diameters are within the spirit and scope of the present invention.

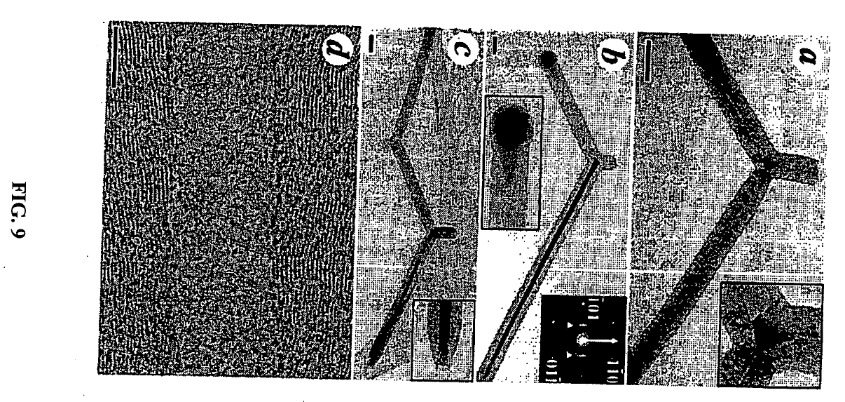

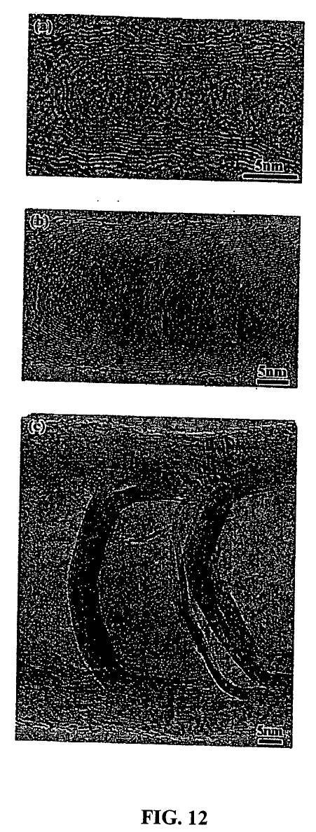

As shown in FIG. 9, Y-junctions of branched CNTs may have hollow cores within the tubular arms of branched CNTs. As shown in the inset of FIG. 9a, a triangular, amorphous particle is frequently found at the center of the Y-junction. Compositional analysis by an x-ray energy dispersive spectrometer (EDS) indicates that the triangular particles consist of calcium (Ca), silicon (Si), magnesium (Mg), and oxygen (O). The calcium (Ca) and silicon (Si) are probably initially contained in the catalyst material. It is frequently observed that one of the two long arms of the Y-junction is capped with a pear-shaped particle (FIG. 9b and lower inset) having a similar chemical composition as that of the aforementioned triangle-shaped particle found within the tubules at the Y-junction. A trace amount of cobalt (Co) from the catalytic material is found at the surface of such pear-shaped particle. FIG. 9b shows that the tubule of the other long arm of the branched CNT is filled with crystalline magnesium oxide (MgO) from the catalytic material (confirmed by diffraction contrast image in the EDS spectrograph). The upper right inset in FIG. 9b shows selected area diffraction patterns, which indicate that one of the (110) reflections, (101), of the magnesium oxide (MgO) rod is parallel to (0002) reflection (indicated by arrow heads) from carbon nanotube walls. Therefore, the magnesium oxide (MgO) rod axis is along (210). Additionally, Y-junctions filled with continuous single crystalline magnesium oxide (MgO) from one arm, across a joint, to another arm can also be obtained. FIG. 12c shows a double Y-junction, wherein only one arm of the right-side Y-junction is filled with single crystal MgO. The inset of FIG. 12b shows a magnified image of the end of the MgO filled arm, illustrating an open tip that provides entry of MgO into the CNT Y-junctions. FIG. 12d shows a highly magnified partial Y-junction, which is well graphitized, and consists of about 60 concentric graphite layers (partially shown) in its tubule arms, and a hollow core with a diameter of about 8.5 nm. CNTs can comprise a plurality of free standing, linearly extending carbon nanotubes originating from and attached to the surface of a catalytic substrate having a micro-particulate, mesoporous structure with particle size ranging from about 0.1 μm to about 100 μm, and extending outwardly from the substrate outer surface. The morphology of individual CNT tubules can either be cylindrical with a hollow core, or be end-capped, stacked and conical (“bamboo-like”). Both morphological forms may be comprised of either a single layer or multiple layers of graphitized carbon. CNTs can also be separated from the catalytic substrate material and exist in a free-standing, unsupported form.

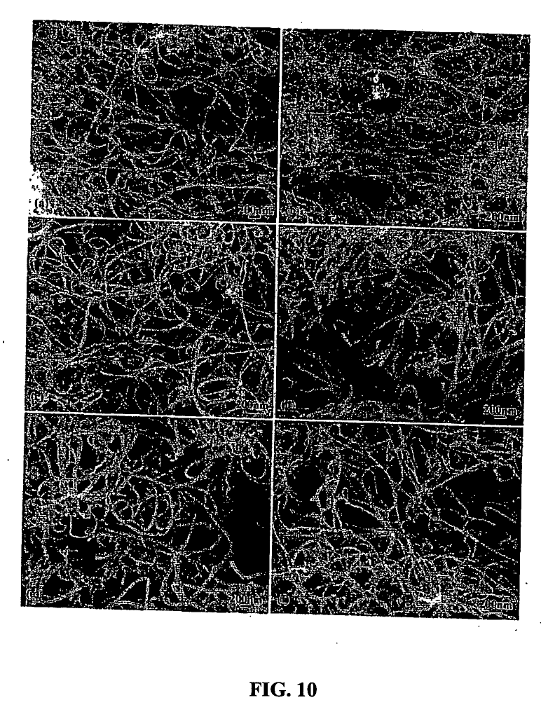

FIG. 10 shows SEM photomicrographs of CNTs grown at various gas pressures. FIG. 10a shows CNTs grown at a gas pressure of 0.6 torr. FIG. 10b shows CNTs grown at a gas pressure of 50 torr. FIG. 10c shows CNTs grown at a gas pressure of 200 torr. FIG. 10d shows CNTs grown at a gas pressure of 400 torr. FIG. 10e shows CNTs grown at a gas pressure of 600 torr. FIG. 10f shows CNTs grown at a gas pressure of 760 torr.

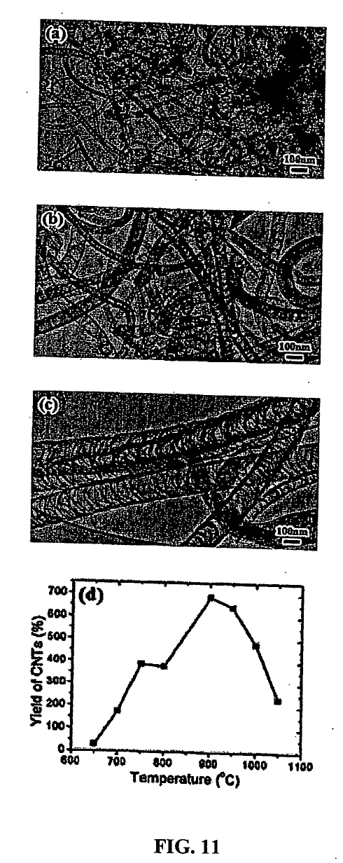

FIG. 11 show low magnification TEM photomicrographs of “bamboo-like” CNTs synthesized at various temperatures. FIG. 11a shows CNTs synthesized at 800° C. FIG. 11b shows CNTs synthesized at 950° C. FIG. 11c shows CNTs synthesized at 1050° C. FIG. 11d shows CNT yield dependence on reaction temperature.

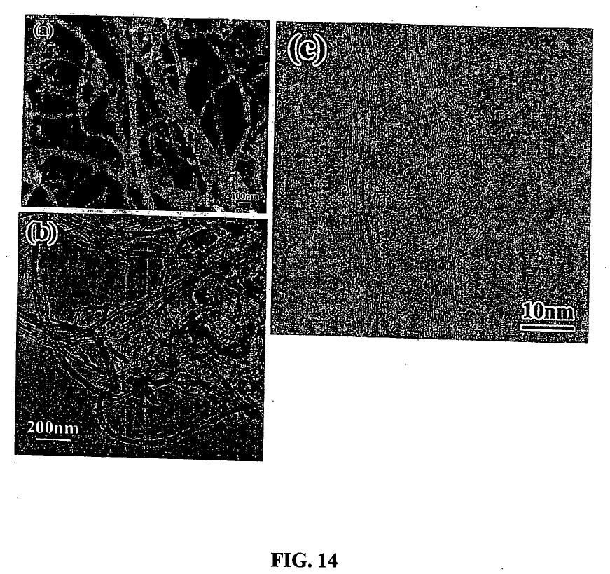

In another embodiment of the present invention, the reinforced CNT material comprises a microparticulate oxide material that is bound substantially on the surface of the CNT tubules. The microparticulate oxide materials of the invention can be metallic or non-metallic oxides. Examples of oxide materials include, but are not limited to, magnesium oxide (MgO) and boron oxide (B₂O₃). As shown in FIG. 14 amorphous boron oxide (B₂O₃) nanolumps are formed on multi-walled CNTs. FIG. 14a shows a scale bar equal to 100 nanometers. FIG. 14b shows a scale bar equal to 200 nanometers. FIG. 14c shows a scale bar equal to 10 nanometers.

CNTs can be grown by any suitable method known in the art. In one embodiment, multi-wall CNTs can be grown by any CVD method, including but not limited to, plasma enhanced chemical vapor deposition (PECVD), hot filament chemical vapor deposition (HFCVD), or synchrotron radiation chemical vapor deposition (SRCVD). Suitable methods for growing CNTs are described by Li, et al., Appl. Phys. A: Mater. Sci. Process, 73, 259 (2001) and U.S. application Ser. No. 10/151,382, filed on May 20, 2002, the contents of both these references are hereby incorporated herein by reference in their entireties.

### EXAMPLES

### Example 1

B₄C Nanoparticles Formed by a Reaction of Boron from Thermal Decomposition of MgB₂ with CNTs Yielding Large Quantities of B₄C Nanoparticles

In one embodiment of the present invention, reinforced CNTs are produced through the thermal decomposition of MgB₂. In one embodiment, a large quantity of boron carbide (B₄C nanoparticles) can be produced on CNTs wherein the CNTs are multi-walled and of a bambo-like morphology.

Boron carbide (B₄C) can be prepared by several methods, such as carbonthermal route of boron oxide (B₂O₃, H₃BO₃, Na₂B₃O7, etc.), reduction of BCl₃ by CH₄ at a temperature of about 1500° C. with laser, direct reaction of carbon with boron, magnesiothermic reduction of B₂O₃ in the presence of carbon at about 1000-1200° C. The industrial method to grow B₄C is carbon-thermal reduction of boric acid at a temperature over 2000° C. At low temperature (about 450° C.), B₄C nanoparticles can be made by using BBr₃ and CCl₄ as the reactants and metallic Na as the co-reductant.

The hardness and yield stress of any material typically increase with decreasing grain size. Commercially available B₄C has grain size around microns. The present invention includes a solid-vapor reaction, through which uniformly sized B₄C nanoparticles may be produced. In one embodiment, the reaction produces nanoparticles less than 100 nm in size. In one embodiment of the invention, the use of these nanometer grain sizes will significantly enhance the mechanical properties of a composite. In one embodiment, a toughness of the composite is increased by use of these nanometer grain sizes. Those skilled in the art will recognize that various particle sizes are within the spirit and scope of the present invention.

In one embodiment of the current invention, boron was produced through the thermal decomposition of magnesium diboride (MgB₂), and multiwall carbon nanotubes (CNTs) were used as the carbon source. In one embodiment, a graphite boat was used as the reactor.

The multiwall CNTs were grown by catalytic chemical vapor deposition and purified by HF acid.

Using the same starting materials and a similar reaction procedure, B₄C nanolumps were grown on CNTs. MgB₂ begins to decompose at about 600° C. In vacuum condition, the decomposition was almost complete at about 900° C. Boron from the thermal decomposition of MgB₂ is more chemically reactive so the reaction with CNTs was realized at a relatively low temperature of about 1150° C.

MgB₂ was first mixed with CNTs in a mortar and pestle. The atomic ratio of boron and carbon in the mixture was 5:1. After uniformly mixed, certain amount of mixture was loaded in to the graphite boat, and then was placed into the ceramic tube of the high temperature tube furnace. Before heating up, the tube was pumped to below 0.05 Torr. It was first heated to about 900° C. and kept for 1 h for preliminary decomposition of MgB₂. Then the temperature was increased to about 1150° C. within 0.5 hours and stayed at that temperature for 3 hours for reaction of boron with carbon to form B₄C.

Normally, the as-made sample contains impurities such as Mg₂(BO₃)₃, B₂O₃, etc. To get pure B₄C nanoparticles, purification was carried out in 10% HCl aqueous solution assisted by ultrasonication, followed by vacuum filtration. Microstructure was studied by scanning electron microscope (SEM, JEOL JSM-6340F), x-ray diffraction (XRD), and filed emission transmission electron microscope (TEM, JEOL 2010F). The TEM is also equipped with an x-ray energy dispersive spectrometer (EDS). TEM specimen were prepared by dispersing a drop of B₄C nanoparticle-acetone solution on a holey carbon grid.

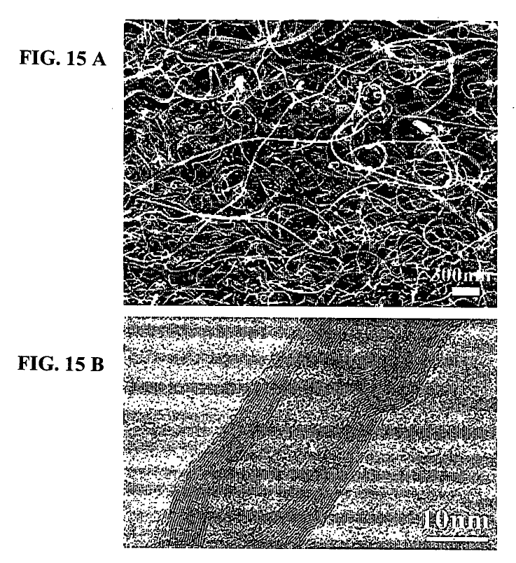

FIG. 15a is an SEM image of the CNTs used as the carbon source. FIG. 15b is the high resolution TEM (HRTEM) image of a typical CNT. In FIG. 15b, the bamboo structure is clearly seen in almost every CNT. After reaction, a small amount of CNTs was still visible during SEM examination of the sample, indicating an incomplete conversion of CNTs into B₄C nanoparticles.

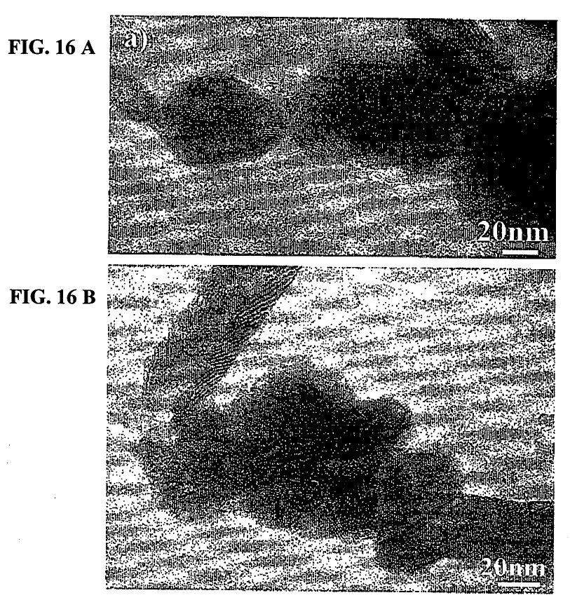

Under TEM study, B₄C nanoparticles were formed at either the end (see FIG. 16a) or at the broken place (see FIG. 16b). These observations clearly show that the growth mechanism of B₄C is: boron from the thermal decomposition of MgB₂ easily reacts with the dangling carbon atoms located at either the ends or the bamboo sections of each CNT. Therefore, the bamboo of the starting CNTs allows for the formation of a large quantity of B₄C nanoparticles. With uniformly sectioned high density bamboo and small diameter, it is expected that even smaller uniformly sized B₄C nanoparticles should be readily formed.

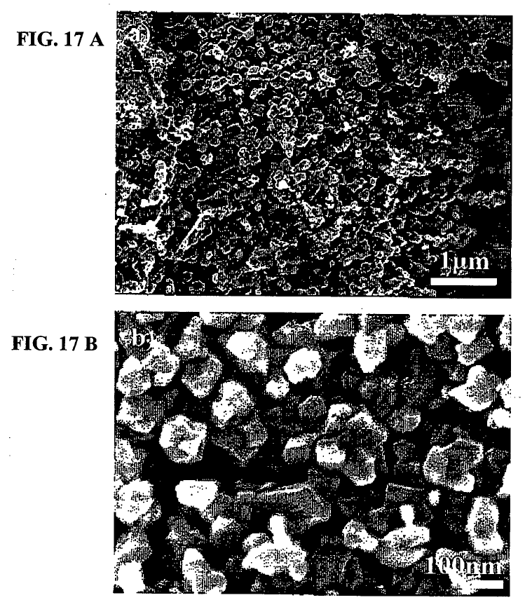

FIG. 17a is an SEM image of the purified B₄C nanoparticles to show their abundance and size uniformity. In FIG. 17b, a higher magnification SEM image is shown to demonstrate that the nanoparticles are faceted and seems to be single crystals. In one embodiment, the average size of the particles is about 80 nm.

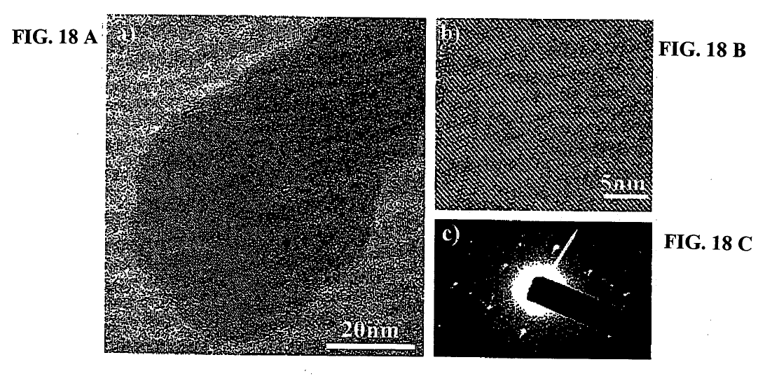

In FIG. 18a, a TEM image of a single particle is shown. EDS composition analysis on the nanoparticle shows that it mainly contains carbon and boron (the atomic percentage: B=70.26%, C=27.23%), and a very small amount of oxygen (the atomic percentage of oxygen is 2.28%). Oxygen is probably from B₂O₃ on the B₄C nanoparticles. It is well-known that B₄C absorbs oxygen very easily and forms B₂O₃ on the particle surface. To further prove that the particle is a single crystal B₄C, a high TEM lattice image was shown in FIG. 18b. The lattice spacing measured from FIG. 18b is in good agreement with that of B₄C. FIG. 18c shows a fast-Fourier transformation image of the HRTEM image 18b.

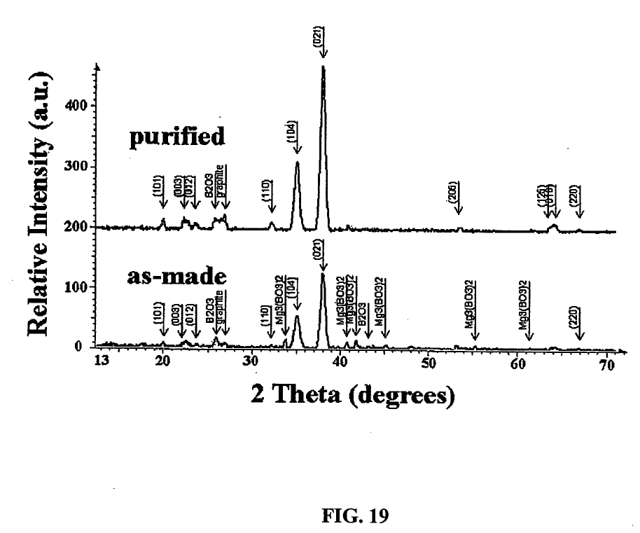

FIG. 19 is the XRD spectra of the pre-purification step (bottom) and purified (top) B₄C nanoparticles. In the bottom spectrum from the pre-purification step sample, peaks due to impurities such as Mg₂(BO₃)₃ and B₂)₃ are clearly seen. After purification, the impurities almost disappeared, but there still some very weak peaks of B₂O₃ and graphite. It may not be due to the incomplete removal of B₂O₃, but due to the quick formation of B₂O₃ on B₄C, a well-known fact in micro sized B₄C particles. In fact, the nano B₄C should be even susceptible to oxidation due to much larger surface area. The peaks of B₄C seem to be broader than those from the micro sized B₄C powder, obviously due to the nano size effect. It is also interesting to note that a weak peak from CNTs is still visible, indication of incomplete conversion of CNTs. By deliberately adjusting the relative ratio of MgB₂ and CNTs in the starting mixture, certain amount of CNTs will be remained and uniformly distributed in B₄C nanoparticles. It is worth pointing out that the remaining CNTs are defect free so they should be much stronger than the highly defected CNTs. This mixture of B₄C and CNTs can be simply hotpressed and superior toughness is expected. Such work is in progress now. The strong peaks in purified B₄C are well-matched with those from B₄C powder.

In summary, B₄C nanoparticles were formed by a reaction of boron from thermal decomposition of MgB₂ with CNTs. The single crystal nature of each B₄C nanoparticle is well demonstrated by SEM, XRD, and TEM characterizations. In comparison with the conventional synthesizing routes, the current technology is very easy to obtain large quantity B₄C nanoparticles. In addition, it is expected that a mixture with certain ratio of B₄C over CNTs can be obtained for the following CNTs-reinforced B₄C nanocomposite. The reaction happens at either the ends or defect sites of the CNTs. To obtain even smaller nanoparticles, smaller CNTs diameter and higher defect (bamboo) density is required.

### Example 2

Ratio of Boron to Carbon; Effect on Physical Properties

In one embodiment of the invention, adjusting the boron to carbon ratio (B:C) was seen to improve the physical properties of the reinforced CNTs; additionally, in one embodiment, the use of a plasma pressure compact device was seen to improve the physical properties of the reinforced CNTs.

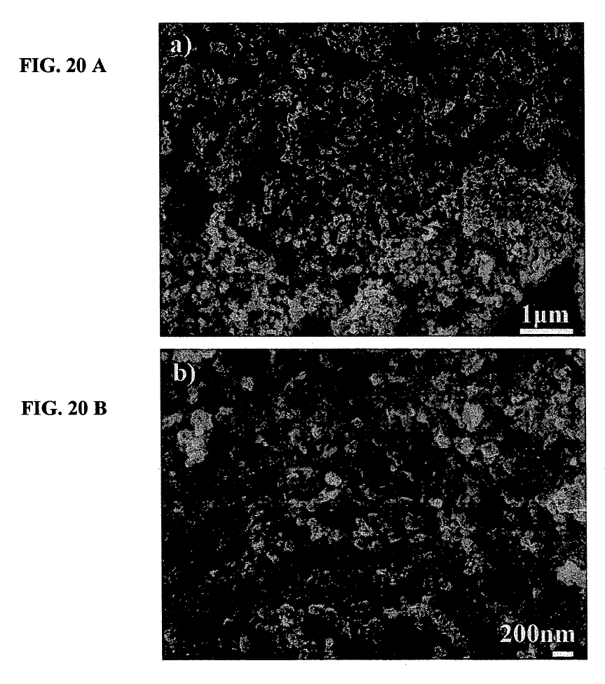

B₄C particles of approximately 100 nm size were synthesized through reaction of MgB₂ with multiwall carbon nanotubes (MWCNTs). The mixture of MgB₂ and MWCNTs were heated to 1150° C. and kept for 2 hrs under a pressure of 10⁻² Torr. Different ratio of starting materials can produce either B₄C-rich or CNTs-rich sample. Scanning electron microscopy (SEM) images show the uniform dispersion of B₄C among CNTs after reaction (see FIG. 20).

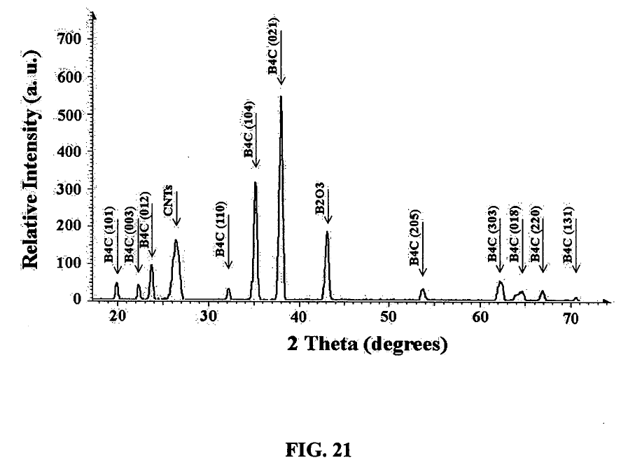

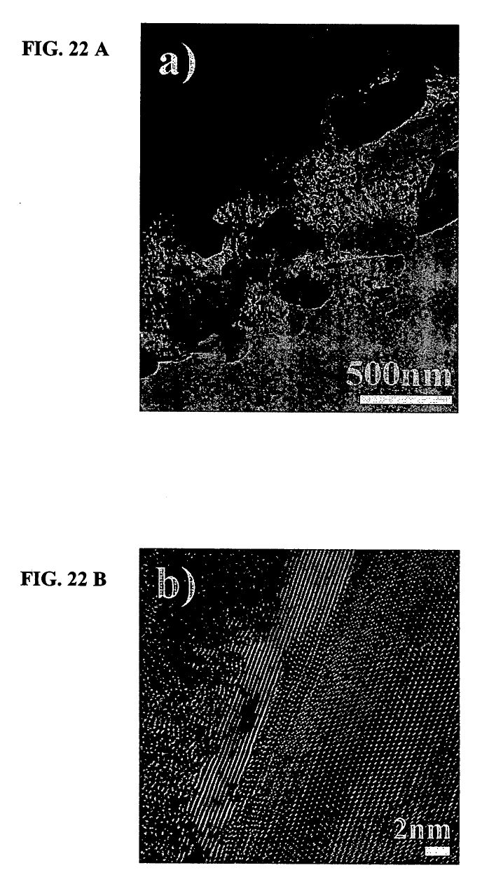

X-ray diffraction (XRD)(see FIG. 21) shows the sample mainly contains B₄C and CNTs. Clean boundaries, possibly indicating strong covalent bonds between B₄C and CNTs, can be observed from transmission electron microscope (TEM) (FIG. 22). Thus, we expect that B₄C and CNTs can support each other and have both high hardness and toughness.

In one embodiment, a plasma pressure compact process is used for sintering. Unlike conventional hot press which has an external heat source, a few thousand amperes DC current passes through the sample to generate a large amount of heat. As such, less time is needed to reach the required temperature, which reduces the chance of grain growth. The main parameters used during sintering were current and pressure. Samples were held at maximum current for about 5 minutes.

TABLE 1
Hot press conditions, density, and hardness.

| | | | | | D | | | |
|---|---|---|---|---|---|---|---|---|
| # | B:C | M(g) | I(A) | P(MPa) | (g/cm³) | % | Al₂O₃ | KHN(s/t) |
| 1 | 3.5:1 | 3 | 3900 | 32 | 1.74 | 70 | 0 | 266 |
| 3 | 3.5:1 | 4.4 | 4000 | 64 | 2.05 | 82 | 0 | 574 |
| 5 | 3.5:1 | 5 | 4000 | 64 | 2.35 | 93.4 | 1 wt % | 955 |

M = Sample Mass, I = Current, P = Pressure, D = Density, % = relative density of the theoretical value of B₄C, Al₂O_{3 = weight percent in the sample. KHN = Knoop hardness number.}

Table 1 shows that higher pressure produces higher density, Al₂O₃ is an effective additive for higher density (1 wt % Al₂O₃ improves the final density significantly) and hardness increases with density.

The next round of hot press was done with 1 wt % A1₂O₃.

TABLE 2
Hot press conditions, hardness, and fractural toughness.

| | | | | D | | | |
|---|---|---|---|---|---|---|---|
| # | B:C | I(A) | P(MPa) | (g/cm³) | % | FT(Mpam^{1/2}) | HV(Kg/mm) |
| 6 | 5:1 | 4000 | 64 | 2.30 | 91 | 4.45 | 2064 |
| 7 | 3.5:1 | 4200 | 64 | 2.49 | 99 | 5.56 | 1213 |
| 8 | 3.5:1 | 4300 | 64 | 2.48 | 98.6 | 3.54 | 2133 |

FT = fractural toughness by Vicker's method, HV = Vicker's hardness

In comparison, the commercial cercom hot pressed boron carbide was used as a reference. This material is used for light armor applications. The Vicker's toughness and hardness of cercom material is 3.23 MPam^{1/2} and 3084 kg/mm², respectively. From the value shown in Table 2, sample #6 comprises the most preferred properties, having approximately 80% of the cercom material hardness and 130% of the toughness. Sample #7 has the highest toughness, but the hardness is relatively low. Hardness of sample #8 is closest with cercom but it does not show obvious toughness enhancement. From SEM and TEM analysis, we find grain growth after sintering, which explains why the enhancement is not as significant as expected. The grain growth may be due to the high temperature used for sintering.

In summary, several tests were performed on the B₄C-CNT composite samples of the present invention. Samples with higher boron ratio had the most preferred properties.

### Example 3

Synthesis of Reinforced CNTs having Boron Carbide (BₓC_{y}) Nanolumps Formed Substantially on the Surface of the CNTs

The multi-wall CNTs were grown by catalytic chemical vapor deposition method (see Li, et al., Appl. Phys. A: Mater. Sci. Process, 73, 259 (2001), the contents of which is incorporated herein by reference in its entirety) and purified by hydrofluoric acid (HF). Magnesium diboride (MgB₂), a new superconducting material, is used as the source of boron. The synthesis of magnesium diboride (MgB₂) can be synthesized by combining elemental magnesium and boron in a sealed (Ta) tube in a stoichiometric ratio and sealed in a quartz ampule, placed in a box furnace at a temperature of about 950° C. for about 2 hours. Powder MgB₂ with average grain size of about 1 micrometer decomposes at a temperature of about 600° C. Thermally decomposed boron is more chemically reactive so the solid-state reaction can be performed at relatively low temperatures. The nanotubes were mixed gently with MgB₂ powder first, then wrapped by a tantalum (Ta) foil to form an assembly, and finally the assembly was placed in a ceramic tube furnace, and pumped to below about 0.5 torr by mechanical pump. The sample was heated at about 1100° C. to about 1150° C. for about 2 hours. Microstructural studies were carried out by a JEOL JSM-6340F scanning electron microscope (SEM) and JEOL 2010 transmission electron microscope (TEM), respectively. The TEM is equipped with an X-rays energy dispersive spectrometer (EDS). A TEM specimen was prepared by dispersing CNTs into an acetone solution by sonication and then putting a drop of the solution on a holey carbon grid.

### Example 4

Determining the Composition of BₓC_{y} Nanolumps

In order to find out whether the nanolumps are boron carbide, a high-resolution transmission electron microscopic (HRTEM) image of a nanolump is taken and shown in FIG. 3a. The carbon nanotube nature has been preserved after the reaction. The BₓC_{y} nanolump is crystalline. FIG. 3b is an enlarged HRTEM image of the top part of FIG. 3a. FIG. 3c shows a fast-Fourier transformation (FFT) image of the HRTEM image shown in FIG. 3b. The diffraction pattern obtained from FFT (FIG. 3c) is indexed as one from zone axis (\overline{1}11) of B₄C. Structure parameters of B₄C for the indexing are space group R3m: (166) and lattice parameters, a=0.56 nm, c=1.21 nm. As shown in FIG. 3b, the simulated HRTEM image using parameters defocus -30 nm and thickness 20 nm also matches with experimental image very well. Although no boron was detected by the EDS analysis, it is reasonable to draw a conclusion that the nanolumps are of the formula, BₓC_{y}, since both calculated HRTEM image and diffraction pattern match with experimental ones very well when using structural parameters of B₄C. The ratio between boron and carbon in nanolumps may differ from B₄C dramatically because boron and carbon atoms can easily substitute each other. Twin boundaries were often observed in B₄C nanolumps. As shown in FIG. 3d, the twin boundary is along either (101) or (01\overline{1}) planes.

### Example 5

Preparation of Catalyst Substrate for Synthesis of Linear CNTs

Mesoporous silica containing iron nanoparticles were prepared by a sol-gel process by hydrolysis of tetraethoxysilane (TEOS) in the presence of iron nitrate in aqueous solution following the method described by Li et al. (Science, (1996), Vol. 274, 1701-3) with the following modification. The catalyst gel was dried to remove excess water and solvents and calcined for about 10 hours at about 450° C. and about 10⁻² torr to give a silica network with substantially uniform pores containing iron oxide nanoparticles that are distributed within. The catalyst gel is then ground into a fine, micro-particulate powder either mechanically using a ball mill or manually with a pestle and mortar. The ground catalyst particles provide particle sizes that range between about 0.1 μm and about 100 μm under the grinding conditions.

### Example 6

Preparation of Catalyst Substrate for Synthesis of branched CNTs

Magnesium oxide (MgO) supported cobalt (Co) catalysts were prepared by dissolving about 0.246 g of cobalt nitrate hexahydrate (Co(NO₃)₂.6H₂O, 98%) in 40 ml ethyl alcohol, following which immersing about 2g of particulate MgO powder (−325 mesh) were added to the solution with sonication for about 50 minutes. The solid residue was filtered, dried and calcined at about 130° C. for about 14 hours.

### Example 7

General Synthetic Procedure for Linear CNTs

The synthesis of CNTs is carried out in a quartz tube reactor of a chemical vapor deposition (CVD) apparatus. For each synthetic run, about 100 mg of the micro-particulate catalyst substrate was spread onto a molybdenum boat (about 40×100 mm²) either mechanically with a spreader or by spraying. The reactor chamber was then evacuated to about 10⁻² torr, following which the temperature of the chamber was raised to about 750° C. Gaseous ammonia was introduced into the chamber at a flow rate of about 80 sccm and maintained for about 10 minutes, following which acetylene at a flow rate of about 20 sccm was introduced for initiate CNT growth. The total gas pressure within the reaction chamber was maintained at a fixed value that ranged from about 0.6 torr to about 760 torr (depending on desired morphology for the CNTs). The reaction time was maintained constant at about 2 hours for each run. The catalytic substrate containing attached CNTs were washed with hydrofluoric acid, dried and weighed prior to characterization.

### Example 8

General Synthetic Procedure for Branched CNTs

The MgO supported cobalt catalyst of Example 5 were first reduced at about 1000° C. for about 1 hour in a pyrolytic chamber under a flow of a mixture hydrogen (about 40 sccm) and nitrogen (about 100 sccm) at a pressure of about 200 torr. The nitrogen gas was subsequently replaced with methane (about 10 sccm) to initiate CNT growth. The optimum reaction time for producing branched CNTs was about 1 hour.

### Example 9

Characterization of CNT Morphology and Purity by Scanning Electron Microscopy (SEM), and Tubule Structure and Diameter by Transmission Electron Microscopy (TEM)

Scanning electron microscopy (SEM) for characterization and verification of CNT morphology and purity was performed on a JEOL JSM-6340F spectrophotometer that was equipped with an energy dispersive x-ray (EDS) accessory. Standard sample preparation and analytical methods were used for the SEM characterization using a JEOL JSM-6340F microscope. SEM micrographs of appropriate magnification were obtained to verify tubule morphology, distribution and purity.

Transmission electron microscopy (TEM) to characterize individual tubule structure and diameter of the CNTs was performed on a JEOL 2010 TEM microscope. Sample specimens for TEM analysis were prepared by mild grinding the CNTs in anhydrous ethanol. A few drops of the ground suspension were placed on a micro-grid covered with a perforated carbon thin film. Analysis was carried out on a JEOL 2010 microscope. TEM micrographs of appropriate magnification were obtained for determination of tubule structure and diameter.

### Example 10

Synthetic Procedure for Oxide Reinforced CNTs

Reinforced CNT materials comprising microparticulate oxide are obtained in a manner substantially similar to the procedure described in Example 3. The oxide source materials used are magnesium oxide (MgO) and boron oxide (B₂O₃). The microparticulate oxide formation on CNTs is carried out a pressure of 5 torr.

Although the examples described herein have been used to describe the present invention in detail, it is understood that such detail is solely for this purpose, and variations can be made therein by those skilled in the art without departing from the spirit and scope of the invention.

All patents, patent applications, and published references cited herein are hereby incorporated herein by reference in their entirety. While this invention has been particularly shown and described with references to preferred embodiments thereof, it will be understood by those skilled in the art that various changes in form and details may be made therein without departing from the scope of the invention encompassed by the appended claims.

What is claimed is:

1. A method of producing reinforced carbon nanotubes (CNTs), comprising:
growing a plurality of CNTs;
mixing an amount of magnesium diboride with the CNTs to produce a mixture;
placing the mixture in a reaction vessel;
placing the reaction vessel into a heating device;
creating a desired pressure within the heating device;
heating the mixture by raising a starting temperature of the heating device to a first desired temperature and maintaining the first desired temperature for a first desired period of time to begin a thermal decomposition of magnesium diboride; and
heating the mixture to a second desired temperature for a second desired period of time to react an amount of boron with an amount of carbon to form reinforced CNTs having a plurality of boron carbide nanoparticles.

2. The method of claim 1 further comprising purifying the reinforced CNTs.

3. The method of claim 2 wherein purifying comprises:
adding a hydrochloric acid solution to the reinforced CNTs;
applying ultrasonication; and
applying vacuum filtration.

4. The method of claim 1 wherein the reaction vessel is a graphite boat.

5. The method of claim 1 wherein the plurality boron carbide nanoparticles are crystals.

6. The method of claim 1 wherein the CNTs are multi-wall CNTs.

7. The method of claim 1 wherein the CNTs have a bamboo-like morphology.

8. A method of producing a composite material reinforced with reinforced carbon nanotubes (CNTs), comprising:
mixing an amount of magnesium diboride with an amount of CNTs to produce a mixture;
placing the mixture in a reaction vessel;
placing the reaction vessel into a heating device;
creating a desired pressure within the heating device;
heating the mixture to a first desired temperature for a first desired period of time in order to begin a thermal decomposition of magnesium diboride;
heating the mixture to a second desired temperature for a second desired period of time to allow for a reaction of an amount of boron with an amount of carbon to produce reinforced CNTs having a plurality of boron carbide nanoparticles;
providing a composite material; and
adding the reinforced CNTs to the composite material.

9. The method of claim 8 further comprising purifying the reinforced CNTs.

10. The method of claim 9 wherein purifying comprises:
adding a hydrochloric acid solution to the reinforced CNTs;
applying ultrasonication; and
applying vacuum filtration.

11. The method of claim 8 wherein the reaction vessel is a graphite boat.

12. The method of claim 8 wherein the plurality of boron carbide nanoparticles are crystals.

13. The method of claim 8 wherein the CNTs are multi-wall CNTs.

14. The method of claim 8 wherein the CNTs have a bamboo-like morphology.

15. A method of producing reinforced carbon nanotubes (CNTs), comprising:
mixing an amount of magnesium diboride with an amount of CNTs to produce a mixture wherein the amount of magnesium diboride and the amount of CNTs are selected in order to produce a desired ratio of boron to carbon in a reinforced CNT;
placing the mixture in a plasma pressure compact device;
creating a desired pressure within the plasma pressure compact device;
passing a current through the mixture to heat the mixture; and
removing the reinforced CNTs from the plasma pressure compact device.

16. The method of claim 15 wherein the desired ratio of boron to carbon in the reinforced CNTs is about 5 to 1.

17. The method of claim 15 wherein the desired ratio of boron to carbon in the reinforced CNTs is about 3.5 to 1.

18. The method of claim 15 further comprising adding a desired weight percent of aluminum oxide to the mixture.

19. The method of claim 15 wherein the CNTs are multiwall CNTs.

20. The method of claim 15 wherein the CNTs have a bambo-like morphology.
